(19) United States
(12) Patent Application Publication
(10) Pub. No.: US 2015/0028759 A1
(43) Pub. Date: Jan. 29, 2015

(54) LED Lighting System Based on a Multiple-output Constant Current LED Driver

(71) Applicant: YaXi Ni, Rancho Cucamonga, CA (US)

(72) Inventor: YaXi Ni, Rancho Cucamonga, CA (US)

(73) Assignee: ATG ELECTRONICS, INC., Rancho Cucamonga, CA (US)

(21) Appl. No.: 14/073,802

(22) Filed: Nov. 6, 2013

Related U.S. Application Data
(60) Provisional application No. 61/857,742, filed on Jul. 24, 2013.

(51) Int. Cl. H05B 33/08

(52) U.S. Cl. CPC H05B 33/0809
USPC 315/201

(57) ABSTRACT

An LED lighting system includes a multiple output constant current LED driver and a plurality of LED arrays. The LED driver has AC/DC converter, PFC circuit, DC/DC converter and a plurality of DC/DC modules. The PFC circuit is connected to AC/DC converter, the DC/DC converter is connected to the PFC circuit, and the DC/DC modules are connected to DC/DC converter. The LED arrays are connected to DC/DC modules.

### CROSS-REFERENCE TO RELATED APPLICATIONS

Provisional application No. 61/857,742, filed on Jul. 24, 2013

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The present invention relates to LED lighting system based on a multiple-output constant current LED driver. In particular, the LED lighting system consists of multiple LED arrays and an LED driver with multiple independent constant current outputs.

### BACKGROUND OF THE INVENTION

The light-emitting diode (LED) is a type of semiconductor device which consumes electricity and converts it into light. The light-emitting diode works preferably on a constant current circuit to maximize its performance and life span.

A typical traditional LED lighting system as shown in FIG. 1 consists of multiple LED arrays 15₁, 15₂ . . . , 15ₙ and a single-output constant current LED driver 10. The said LED driver 10 further consists of AC/DC converter 11, PFC circuit 12 and DC/DC converter 13. The LED arrays 15₁, 15₂ . . . , 15ₙ comprise a plurality of light-emitting diodes respectively and work at constant current source; and are connected in parallel connection and then coupled to the DC/DC converter 13 which is the output of the said LED driver 10. The AC/DC converter 11 converts AC line voltage current such as 110VAC to DC current, which further flows through PFC circuit 12 and DC/DC converter 13 and is finally converted into constant current DC such as 450 mA. The LED arrays 15₁, 15₂ . . . , 15ₙ coupled to the DC/DC converter 13 are distributed and supplied equally with constant current DC equally. However in this design, in case one or more LED arrays have open circuits and stop working, the current used to drive the open-circuited LED arrays will be used to drive the rest LED arrays. Thus the rest LED arrays will be over driven and tend to lose light faster or fail. And it will further lead to failure of the whole LED lighting system.

### SUMMARY OF THE INVENTION

It would be desirable to provide an LED lighting system, of which each LED array is powered separately.

It would be desirable to introduce a multiple-output LED driver into the LED lighting system. Each output of the LED driver is independent and coupled with an LED array. In this LED lighting system, the LED driver converts AC line voltage, outputs multiple constant current DC independently. Each output of the LED driver is coupled with one LED array and each LED array is configured to receive current from the output coupled with. In case any LED array has an open circuit failure, the output of the LED driver coupled with will be shut down instead of transferring the current to other outputs. Thus the other outputs still output rated constant current DC and the LED arrays coupled with will not be over driven.

### BRIEF DESCRIPTION OF THE DRAWINGS

The present invention will be further understood from the following description with reference to the accompanying drawings, in which:

FIG. 1 is a block diagram illustrating a typical LED lighting system comprising a single-output LED driver and multiple LED arrays, as employed by the prior art.

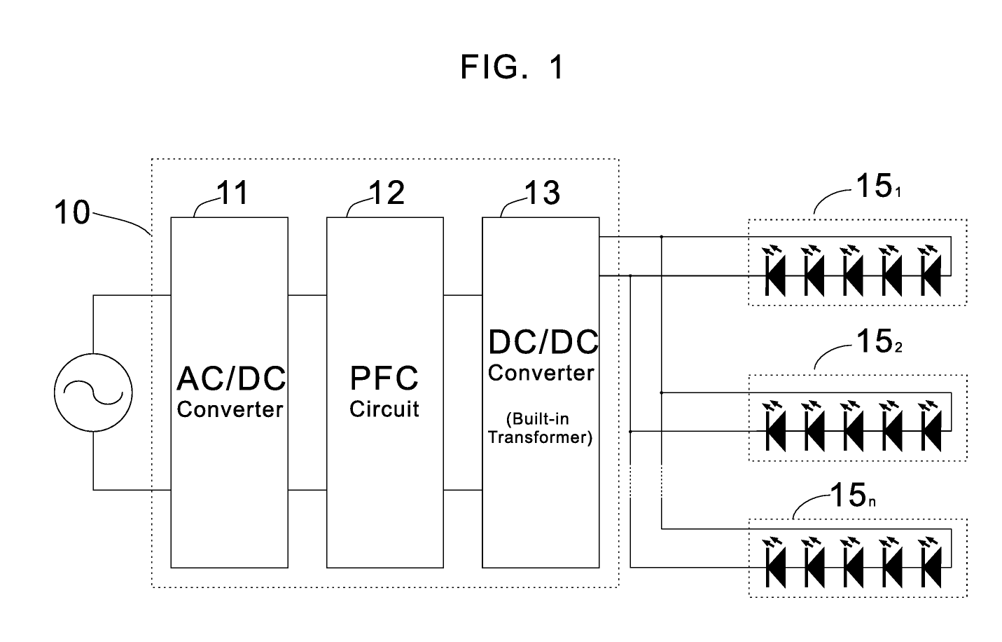

FIG. 2 is a block diagram illustrating an LED lighting system comprising a multiple-output LED driver and multiple LED arrays.

FIG. 3 illustrates a first embodiment of an LED lighting system with multiple LED tube lamps and a multiple-output LED driver used to retrofit a fluorescent troffer fixture in accordance with the invention.

FIG. 4 illustrates a second embodiment of an LED lighting system with multiple LED strips and a multiple-output LED driver used to retrofit a fluorescent troffer fixture in accordance with the invention.

FIGS. 5a and 5b illustrate a third embodiment of an LED lighting system with multiple LED strips and a multiple-output LED driver installed in a troffer fixture in accordance with the invention.

### DETAILED DESCRIPTION OF THE INVENTION

The present invention relates to an LED lighting system which comprises multiple LED arrays 15₁, 15₂ . . . , 15ₙ and a multiple-output constant current LED driver 16 which may be supplied in an open frame type or in a housing of any desired material (for example plastic, aluminum or sheet steel).

It should be understood that LED arrays 15₁, 15₂ . . . , 15ₙ, characterized in comprising a plurality of light-emitting diodes, are basic elements to constitute an LED lighting system. In real application, the LED arrays could be a plurality of light-emitting diodes arranged on printed circuit boards (PCBs), in tubular elements or on linear elements. The PCB may be fiberglass based type, metal core (for example aluminum) based type, ceramics based type or any other type now known or later developed. The PCB may be rigid or flexible in shape.

It should be also understood that the multiple-output constant current LED driver 16, characterized in essentially comprising a plurality of independent DC/DC modules ¹⁴₁, 14₂ . . . , 14ₙ which are outputs of the said LED driver 16, is a device to supply power to above mentioned LED arrays 15₁, 15₂ . . . , 15ₙ.

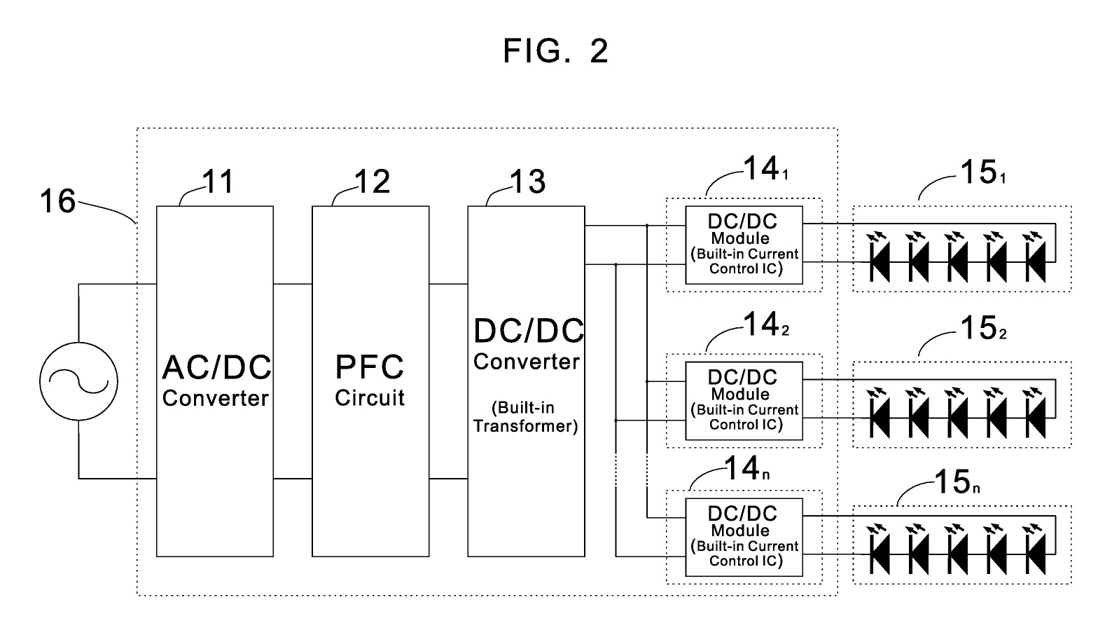

FIG. 2 is a block diagram illustrating an LED lighting system comprising multiple LED arrays 15₁, 15₂ . . . , 15ₙ. Each of the LED arrays 15₁, 15₂ . . . , 15ₙ comprises a plurality of light-emitting diodes. The light-emitting diodes are organized in either series or parallel on PCB and work at constant current circuit (for example 450 mA). The light-emitting diodes may be SMD type, DIP type, COB type or any other type now known or later developed. The LED arrays 15₁, 15₂ . . . , 15ₙ may be arranged on the same PCB or different PCBs.

The LED arrays 15₁, 15₂ . . . , 15ₙ are connected with the DC/DC modules 14₁, 14₂ . . . , 14ₙ of the multiple-output LED driver 16 respectively.

The LED driver 16 consists essentially of an AC/DC converter 11, a PFC circuit 12, a DC/DC converter 13, and multiple DC/DC modules 14₁, 14₂ . . . , 14ₙ which are the outputs of the LED driver. The AC/DC converter 11 accepts AC current (for example 120VAC) from the input end of the said LED driver 16, converts the said AC current to high voltage DC current (for example 120VDC) and supplies to PFC circuit 12. PFC circuit 12 regulates the current and corrects power factor closer to 1, and supplies to DC/DC converter 13 (with built-in transformer). DC/DC converter 13 steps the high voltage DC current (for example 120VDC) down to a low level constant current DC (for example 450 mA, 36VDC) which is supplied to DC/DC modules 14₁, 14₂. . . , 14ₙ. The DC/DC modules 14₁, 14₂ . . . , 14ₙ are the output ends of the said LED driver 16 and supply a certain number of constant current to LED arrays 15₁, 15₂ . . . , 15ₙ which are connected respectively with the said DC/DC modules 14₁, 14₂ . . . , 14ₙ. The amount of constant current that the DC/DC modules 14₁, 14₂ . . . , 14ₙ input and output is configured and controlled by the built-in IC of each said DC/DC module.

Each of the DC/DC modules 14₁, 14₂ . . . , 14ₙ works and outputs power independently to the LED arrays 15₁, 15₂ . . . , 15ₙ connected with. In the event of any one of the LED arrays has an open circuit and stops working, the connected DC/DC module neither outputs current nor transfers the current to other DC/DC modules. Thus other LED arrays are protected from risks of overdriving or faster light depreciation.

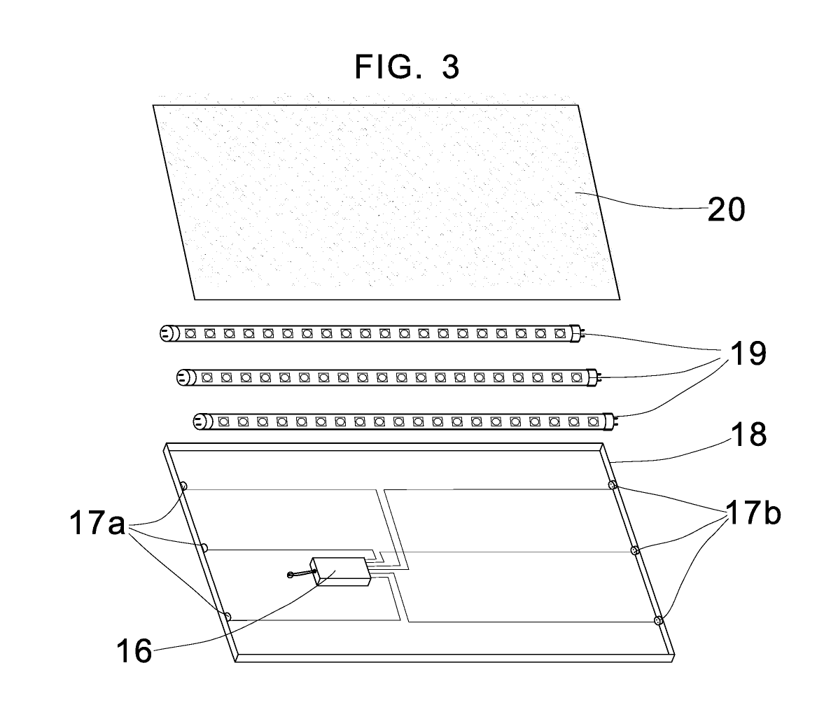

FIG. 3 shows a first embodiment of an LED lighting system based on multiple LED tube lamps 19 installed in a fluorescent troffer fixture 18.

This LED lighting system essentially comprises one multiple-output LED driver 16 and multiple LED tube lamps 19. FIG. 3 shows the said LED driver 16 has three outputs and there are three pieces LED tube lamps 19; however it should be understood that the said LED driver 16 might have more or less than three outputs and there might be more or less than three pieces LED tube lamps 19. And as illustrated in FIG. 3, the fluorescent troffer fixture 18 has bi-pin sockets 17a and 17b and a lens 20. As well known by those skilled in this art, the said fixture 18 may be of 2 foot by 2 foot, 2 foot by 4 foot, and 1 foot by 4 foot sizes and the lens 20 may be parabolic type or prismatic type. LED tube lamps 19 essentially comprises a plurality of light-emitting diodes, an extruded linear heat sink, a linear diffuser and two end caps with bi-pins.

The said LED driver 16 which has power cords on both input end and outputs is arranged inside of the said troffer fixture 18. The input end is connected to AC line voltage power source such as 120VAC and 277VAC; the outputs are connected to bi-pin sockets 17a and 17b respectively. LED tube lamps 19 are arranged with the bi-pin sockets 17a and 17b by pushing the LED tube lamps 19 into the said sockets 17a and 17b. After completing the installation of LED driver 16 and LED tube lamps 19, the lens 20 is then arranged onto the troffer fixture 18.

In this embodiment, in the event of any one of the LED tube lamps 19 has open circuit failure, the rest LED tube lamps 19 continue working without the risk of being overdriven.

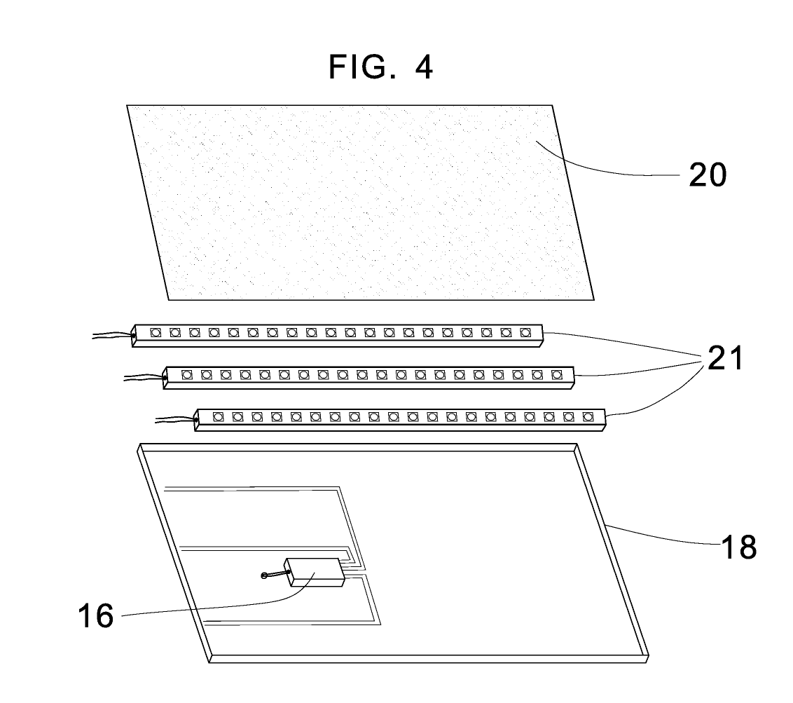

FIG. 4 shows a second embodiment of an LED lighting system based on multiple LED strips 21 installed in a fluorescent troffer fixture 18.

The LED lighting system in the second embodiment essentially comprises one multiple-output LED driver 16 and multiple LED strips 21. The LED strips 21 comprises a plurality of light emitting diodes, a extruded linear element, power cords which may be coupled on one end or two ends of the said linear element. LED strips 21 are arranged inside of the troffer fixture 18 and connected to LED driver 16 via the above mentioned power cords respectively. After completing the installation of LED driver 16 and LED strips 21, the lens 20 is then arranged onto the troffer fixture 18.

Similar to the first embodiment as illustrated in FIG. 3, in the event of any one of the LED strips 21 has open circuit failure, the rest LED strips 21 continue working without the risk of being overdriven.

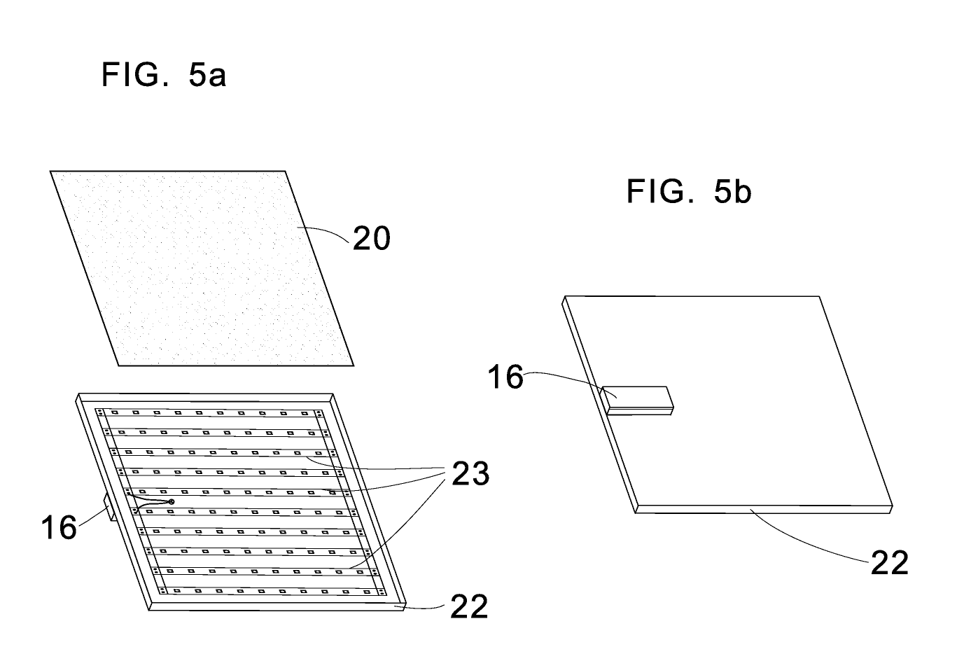

FIGS. 5a and 5b show a third embodiment of an LED lighting system containing multiple LED arrays 23, multiple LED driver 16, baffle assembly 22 and lens 20.

LED arrays 23 are configured and arranged inside of baffle assembly 22, and connected to outputs of LED driver 16 respectively. LED driver 16 is arranged on the back side of baffle assembly 22; lens 20 is arranged on the front side of the baffle assembly 22.

We claim:

1. An LED lighting system comprising:
a multiple output LED driver having AC/DC converter, PFC circuit coupled to said AC/DC converter, DC/DC converter coupled to said PFC circuit, and a plurality of DC/DC modules;
and a plurality of LED arrays, each said LED array coupled to one of said plurality of DC/DC modules.

2. The LED lighting system according to claim 1, wherein the said LED driver outputs constant current.
